(19) United States
(12) Patent Application Publication
(10) Pub. No.: US 2024/0381361 A1
(43) Pub. Date: Nov. 14, 2024

(54) METHOD AND DEVICE USED FOR WIRELESS COMMUNICATION

(71) Applicants: Qiaoling YU, Shanghai (CN); Xiaobo ZHANG, Shanghai (CN)

(72) Inventors: Qiaoling YU, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/656,600

(22) Filed: May 7, 2024

(30) Foreign Application Priority Data
May 11, 2023 (CN) 202310530935.X

(51) Int. Cl. H04W 72/21; H04W 72/04

(52) U.S. Cl. CPC H04W 72/21; H04W 72/04

(57) ABSTRACT

The present application provides a method and device for wireless communications. A communication node receives a first message, the first message is configured with an uplink grant, and any two uplink grants configured by the first message are non-overlapping in time; transmits first control information in a first uplink grant, the first control information indicates whether a target uplink grant is unused, the first uplink grant and the target uplink grant are configured by the first message, the target uplink grant is after the first uplink grant; a candidate for an indication of the first control information for the target uplink grant depends on a first condition set; when the first condition set is met, a candidate for an indication of the first control information for the target uplink grant comprises unused and not unused. The method improves the resource utilization rate and avoids the interference.

### CROSS REFERENCE TO RELATED APPLICATIONS

This application claims the priority benefit of Chinese Patent Application No. 202310530935.X, filed on May 11, 2023, the full disclosure of which is incorporated herein by reference.

### BACKGROUND

### Technical Field

The present application relates to transmission methods and devices in wireless communication systems, and in particular to an indication method and device for control information.

### Related Art

Application scenarios of future wireless communication systems are becoming increasingly diversified, and different application scenarios have put forward performance requirements for systems with high speed and low latency. For example, in order to meet different performance requirements of multiple application scenarios, such as capacity requirements, a WI (Work Item) of “XR (Extended Reality) Enhancements for NR (New Radio)” was approved at 3GPP (3rd Generation Partner Project) RAN (Radio Access Network) #98th plenary:

### SUMMARY

Inventors have found through researches that an indication of control information is a key issue.

To address the above problem, the present application provides a solution for an indication of control information. In response to the above problem description, NR system is used as an example, the present application is also applicable to scenarios such as LTE (Long Term Evolution) or LTE-A (Long Term Evolution Advanced) systems, where similar technical effects can be achieved; furthermore, although the present application provides specific implementation methods for uplink, it can also be used in scenarios such as downlink, so as to achieve technical effects similar to the uplink. Furthermore, a unified design scheme adopted for different scenarios can also help reduce hardware complexity and cost. Furthermore, although the present application provides specific implementation methods for XR scenarios, it can also be used for uplink enhancement scenarios, so as to achieve technical effects similar to XR systems. Furthermore, although the present application provides specific implementation methods for PUSCH (Physical Uplink Shared Channel), it can also be used in scenarios such as PRACH, PUCCH, or PUSCH repetition to achieve technical effects similar to PUSCH; furthermore, although the original intention of the present application is to target Uu air interface, it can also be used for the PC5 interface to achieve technical effects similar to the Uu air interface. Besides, the present application is not only targeted at scenarios of terminals and base stations, but also at Vehicle-to-Everything (V2X) scenarios, terminals and relays as well as communication scenarios between relays and base stations, where similar technical effects can be achieved. Furthermore, although the original intention of the present application is for terminal and base station scenarios, the present application is also applicable to communication scenarios of Integrated Access and Backhaul (IAB), where similar technical effects can be achieved. Furthermore, although the original intention of the present application is for terrestrial network scenario, it is also applicable to non-terrestrial network (NTN) communication scenarios, where similar technical effects can be achieved. Additionally, the adoption of a unified solution for various scenarios contributes to the reduction of hardware complexity and costs.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict.

The present application provides a method in a first node for wireless communications, comprising:
receiving a first message, the first message being configured with an uplink grant, and any two uplink grants configured by the first message being non-overlapping in time; and
transmitting first control information in a first uplink grant, the first control information indicating whether a target uplink grant is unused, the first uplink grant and the target uplink grant being configured by the first message, the target uplink grant being after the first uplink grant;
herein, a candidate for an indication of the first control information for the target uplink grant depends on a first condition set; the phrase that a candidate for an indication of the first control information for the target uplink grant depends on a first condition set comprises: when the first condition set is met, a candidate for an indication of the first control information for the target uplink grant comprises unused and not unused.

In one embodiment, a problem to be solved in the present application comprises: how to determine a candidate for an indication of first control information for the target uplink grant.

In one embodiment, characteristics of the above method comprise: when the first condition set is met, a candidate for an indication of the first control information for the target uplink grant comprises unused and not unused.

In one embodiment, the above method maintains the consistency of the protocol.

In one embodiment, the above method avoids resource waste.

In one embodiment, the above method improves the flexibility of resource scheduling.

According to one aspect of the present application, it is characterized in that a second message is received, and the second message indicates a first symbol set;
herein, the first condition set comprises that the target uplink grant and the first symbol set are non-overlapping.

In one embodiment, the above method avoids the influence on a first symbol set.

In one embodiment, the above method improves the resource utilization efficiency.

According to one aspect of the present application, comprising:
transmitting second control information in a second uplink grant, the second control information indicating whether the target uplink grant is not unused, the second uplink grant being configured by the first message, the second uplink grant being prior to the first uplink grant;
herein, the first condition set comprises that the second control information indicates that the target uplink grant is not unused.

In one embodiment, the above method balances the issues of both resource utilization rate and interference.

According to one aspect of the present application, comprising:
transmitting second control information in a second uplink grant, the second control information indicating that the target uplink grant is unused, the second uplink grant being configured by the first message, the second uplink grant being prior to the first uplink grant;
herein, the first condition set comprises that the first signaling is not received; the second control information triggers the first signaling.

In one embodiment, the above method balances issues of both resource utilization rate and interference.

According to one aspect of the present application, comprising:
transmitting second control information in a second uplink grant, the second control information indicating that the target uplink grant is unused, the second uplink grant being configured by the first message, the second uplink grant being prior to the first uplink grant;
herein, the first condition set comprises that a first time interval reaches a first threshold; the first time interval is related to two of the first uplink grant or the second uplink grant or the target uplink grant.

According to one aspect of the present application, it is characterized in that the phrase that a candidate for an indication of the first control information for the target uplink grant depends on a first condition set comprises: when the first condition set is not met, a candidate for an indication of the first control information for the target uplink grant comprises only a former of the unused and the not unused.

In one embodiment, the above method avoids multiple users from using same resources.

In one embodiment, the above method avoids interference.

According to one aspect of the present application, it is characterized in that the first condition set comprises that the target uplink is not indicated by control information prior to the first control information.

In one embodiment, the above method avoids multiple users from using same resources.

In one embodiment, the above method avoids missed or false detections.

In one embodiment, the above method avoids interference.

The present application provides a method in a second node for wireless communications, comprising:
transmitting a first message, the first message being configured with an uplink grant, and any two uplink grants configured by the first message being non-overlapping in time; and
receiving first control information, the first control information indicating whether a target uplink grant is unused, a first uplink grant and the target uplink grant being configured by the first message, the target uplink grant being after the first uplink grant;
herein, a receiver of the first message transmits the first control information in the first uplink grant; a candidate for an indication of the first control information for the target uplink grant depends on a first condition set; the phrase that a candidate for an indication of the first control information for the target uplink grant depends on a first condition set comprises: when the first condition set is met, a candidate for an indication of the first control information for the target uplink grant comprises unused and not unused.

According to one aspect of the present application, it is characterized in that a second message is transmitted, and the second message indicates a first symbol set;
herein, the first condition set comprises that the target uplink grant and the first symbol set are non-overlapping.

According to one aspect of the present application, comprising:
receiving second control information, the second control information indicating whether the target uplink grant is unused, the second uplink grant being configured by the first message, the second uplink grant being prior to the first uplink grant;
herein, a receiver of the first message transmits the second control information in a second uplink grant; the first condition set comprises that the second control information indicates that the target uplink grant is not unused.

According to one aspect of the present application, comprising:
receiving second control information, the second control information indicating that the target uplink grant is unused, the second uplink grant being configured by the first message, the second uplink grant being prior to the first uplink grant;
herein, a receiver of the first message transmits the second control information in a second uplink grant; the first condition set comprises that the first signaling is not received; the second control information triggers the first signaling.

According to one aspect of the present application, comprising:
receiving second control information, the second control information indicating that the target uplink grant is unused, the second uplink grant being configured by the first message, the second uplink grant being prior to the first uplink grant;
herein, a receiver of the first message transmits the second control information in a second uplink grant; the first condition set comprises that a first time interval reaches a first threshold; the first time interval is related to two of the first uplink grant or the second uplink grant or the target uplink grant.

According to one aspect of the present application, it is characterized in that the phrase that a candidate for an indication of the first control information for the target uplink grant depends on a first condition set comprises: when the first condition set is not met, a candidate for an indication of the first control information for the target uplink grant comprises only a former of the unused and the not unused.

According to one aspect of the present application, it is characterized in that the first condition set comprises that the target uplink is not indicated by control information prior to the first control information.

The present application provides a first node for wireless communications, comprising:
a first receiver, receiving a first message, the first message being configured with an uplink grant, and any two uplink grants configured by the first message being non-overlapping in time; and
a first transmitter, transmitting first control information in a first uplink grant, the first control information indicating whether a target uplink grant is unused, the first uplink grant and the target uplink grant being configured by the first message, the target uplink grant being after the first uplink grant;
herein, a candidate for an indication of the first control information for the target uplink grant depends on a first condition set; the phrase that a candidate for an indication of the first control information for the target uplink grant depends on a first condition set comprises: when the first condition set is met, a candidate for an indication of the first control information for the target uplink grant comprises unused and not unused.

The present application provides a second node for wireless communications, comprising:
a second transmitter, transmitting a first message, the first message being configured with an uplink grant, and any two uplink grants configured by the first message being non-overlapping in time; and
a second receiver, receiving first control information, the first control information indicating whether a target uplink grant is unused, a first uplink grant and the target uplink grant being configured by the first message, the target uplink grant being after the first uplink grant;
herein, a receiver of the first message transmits the first control information in the first uplink grant; a candidate for an indication of the first control information for the target uplink grant depends on a first condition set; the phrase that a candidate for an indication of the first control information for the target uplink grant depends on a first condition set comprises: when the first condition set is met, a candidate for an indication of the first control information for the target uplink grant comprises unused and not unused.

In one embodiment, the present application has at least one of the following advantages over conventional schemes:
avoiding the influence on a first symbol set;
balancing issues of resource utilization rate and interference;
avoiding multiple users from using same resources;
avoiding missed or false detections;
avoiding interference;
avoiding resource waste;
improving the flexibility in resource scheduling;
maintaining the consistency of the protocol.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmission of a first message and first control information according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrate a schematic diagram of a first symbol set being time-domain resources allocated to a candidate uplink grant according to one embodiment of the present application;

FIG. 7 illustrate a schematic diagram of a first symbol set being an activated measurement gap according to one embodiment of the present application;

FIG. 8 illustrates a schematic diagram of a second message indicating a first symbol set in time-domain resources for downlink transmission according to one embodiment of the present application;

FIG. 9 illustrates a flowchart for determining a candidate for an indication of first control information for a target uplink grant according to one embodiment of the present application;

FIG. 10 illustrates a schematic diagram of an uplink grant configured by a first message according to one embodiment of the present application;

FIG. 11 illustrates a schematic diagram of an uplink grant in uplink grants configured by a first message and a first symbol set according to one embodiment of the present application;

FIG. 12 illustrates a schematic diagram of a first uplink grant, a second uplink grant and a target uplink grant according to one embodiment of the present application;

FIG. 13 illustrates a structure block diagram of a processor in a first node according to one embodiment of the present application;

FIG. 14 illustrates a structure block diagram of a processor in a second node according to one embodiment of the present application;

FIG. 15 illustrates a schematic diagram of a first condition set comprises whether a target uplink grant is indicated by control information prior to first control information according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

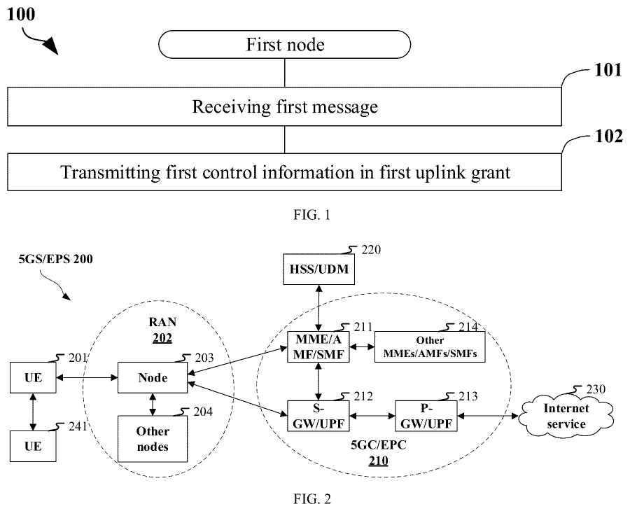

Embodiment 1 illustrates a flowchart of transmission of a first message and first control information according to one embodiment of the present application, as shown in FIG. 1. In FIG. 1, each step represents a step, it should be particularly noted that the sequence order of each box herein does not imply a chronological order of steps marked respectively by these boxes.

In embodiment 1, the first node in the present application receives a first message in step 101, the first message configures an uplink grant, and any two uplink grants configured by the first message are non-overlapping in time; in step 102, transmits first control information in a first uplink grant, the first control information indicates whether a target uplink grant is unused, the first uplink grant and the target uplink grant are configured by the first message, the target uplink grant is after the first uplink grant; herein, a candidate for an indication of the first control information for the target uplink grant depends on a first condition set; the phrase that a candidate for an indication of the first control information for the target uplink grant depends on a first condition set comprises: when the first condition set is met, a candidate for an indication of the first control information for the target uplink grant comprises unused and not unused.

In one embodiment, the first message is a UE-specific signaling.

In one embodiment, the first message is cell-common signaling.

In one embodiment, the first message is used to configure a CG (configured grant).

In one embodiment, the first message is used for semi-persistent configuration.

In one embodiment, the first message is layer-1 signaling.

In one embodiment, the first message is transmitted through a Physical Downlink Control Channel (PDCCH).

In one embodiment, the first message is Downlink control information (DCI).

In one embodiment, a DCI format of the first message is DCI format 0_0.

In one embodiment, a DCI format of the first message is DCI format 0_1.

In one embodiment, a DCI format of the first message is DCI format 0_2.

In one embodiment, a DCI format of the first message is a new DCI format.

In one embodiment, the first message comprises at least one field in a DCI format.

In one embodiment, the first message is DCI with a CRC (Cyclic Redundancy Check) scrambled by a CS (configured scheduling)-RNTI (Radio Network Temporary Identity).

In one embodiment, the first message is an RRC (Radio Resource Control) message.

In one embodiment, the first message is an RRCReconfiguration message.

In one embodiment, the first message is a CellGroupConfig IE.

In one embodiment, the first message comprises an IE whose name comprises ConfiguredGrantConfig.

In one embodiment, the first message is a ConfiguredGrantConfig IE.

In one embodiment, the first message comprises a field, and the field indicates a first index.

In one subembodiment of the above embodiment, a name of the field comprises configuredGrantConfigIndex.

In one subembodiment of the above embodiment, the field is a configuredGrantConfigIndex field.

In one subembodiment of the above embodiment, a name of the field comprises configuredGrantConfigIndexMAC.

In one subembodiment of the above embodiment, the field is a configuredGrantConfigIndex field.

In one subembodiment of the embodiment, the first index is used to indicate a CG configuration.

In one subembodiment of the embodiment, the first index is used to indicate a CG configuration to which an uplink grant configured by the first message belongs.

In one subembodiment of the embodiment, the first index is associated with a CG configuration to which an uplink grant configured by the first message belongs.

In one embodiment, the first message comprises a field, and the field indicates an offset.

In one subembodiment of the embodiment, the offset is used to determine a time interval in time domain between any two adjacent uplink grants configured by the first message.

In one subembodiment of the embodiment, the offset is a time interval between an end time of an uplink grant configured by the first message and a start time of another uplink grant immediately following the uplink grant configured by the first message.

In one subembodiment of the embodiment, the offset is used to determine a time interval between slots occupied by any two adjacent uplink grants configured by the first message.

In one subembodiment of the embodiment, the offset is a time interval between a last slot occupied by an uplink grant configured by the first message and a first one of slots occupied by another uplink grant immediately following the uplink grant configured by the first message.

In one subembodiment of the embodiment, the offset is a non-negative number.

In one subembodiment of the embodiment, the offset is a positive number.

In one subembodiment of the embodiment, the offset is a non-negative integer.

In one subembodiment of the embodiment, the offset is a positive integer.

In one subembodiment of the above embodiment, the offset is measured by slot.

In one subembodiment of the embodiment, the offset is measured by millisecond (ms).

In one subembodiment of the above embodiment, the offset is measured by 0.5 slots.

In one subembodiment of the above embodiment, the offset is measured by 0.5 milliseconds.

In one embodiment, the first message configures an uplink grant within a configuration cycle.

In one embodiment, the first message configures an uplink grant within continuous multiple configuration cycles.

In one embodiment, the first message configures an uplink grant within multiple continuous at least one configuration cycle.

In one embodiment, an uplink grant configured by the first message is related.

In one embodiment, at least two of uplink grants configured by the first message are unrelated.

In one embodiment, an uplink grant configured by the first message is for a same MAC (Medium Access Control) entity:

In one embodiment, an uplink grant configured by the first message is for a same UL BWP (Bandwidth Part).

In one embodiment, an uplink grant configured by the first message occupies PUSCH resources.

In one embodiment, a type of an uplink grant configured by the first message is configured grant Type 1.

In one embodiment, a type of an uplink grant configured by the first message is configured grant Type 2.

In one embodiment, an uplink grant configured by the first message is used for a UL-SCH (Uplink Shared Channel) data transmission.

In one embodiment, an uplink grant configured by the first message belongs to a same CG configuration.

In one embodiment, an uplink grant configured by the first message belongs to a same configuration cycle.

In one subembodiment of the embodiment, the first message is used to determine a start time of the same configuration cycle.

In one subembodiment of the embodiment, the first message is used to determine a duration of the same configuration cycle.

In one subembodiment of the embodiment, the first message is used to determine a number of transmission occasion(s) in the same configuration cycle.

In one subembodiment of the embodiment, the first message is used to determine a time interval between adjacent transmission occasions in the same configuration cycle.

In one embodiment, an uplink grant configured by the first message is different transmission occasions in a configuration cycle.

In one embodiment, an uplink grant configured by the first message is multiple continuous PUSCH resources in a configuration cycle.

In one embodiment, an uplink grant configured by the first message is multiple discontinuous PUSCH resources in a configuration cycle.

In one embodiment, an uplink grant configured by the first message belongs to multiple configuration cycles.

In one embodiment, an uplink grant configured by the first message is different transmission occasions in multiple configuration cycles.

In one embodiment, an uplink grant configured by the first message is multiple continuous PUSCH resources in multiple configuration cycles.

In one embodiment, an uplink grant configured by the first message is multiple discontinuous PUSCH resources in multiple configuration cycles.

In one embodiment, an uplink grant configured by the first message belongs to continuous configuration cycles.

In one embodiment, each uplink grant configured by the first message is an uplink grant.

In one embodiment, each uplink grant configured by the first message is a part of a UL grant.

In one embodiment, each uplink grant configured by the first message is a transmission occasion (TO).

In one embodiment, each uplink grant configured by the first message is a transmission occasion in a configuration cycle.

In one embodiment, each uplink grant configured by the first message is an uplink grant resource block.

In one embodiment, each uplink grant configured by the first message is a PUSCH (Physical uplink shared channel) resource.

In one embodiment, each uplink grant configured by the first message is configured with an index.

In one subembodiment of the above embodiment, the index is unique within a configuration cycle.

In one subembodiment of the above embodiment, the index is used to identify an uplink grant within a configuration cycle.

In one embodiment, slots occupied by any two uplink grants configured by the first message are different.

In one embodiment, numbers of slot(s) occupied by any two uplink grants configured by the first message are the same.

In one embodiment, numbers of slot(s) occupied by any two uplink grants configured by the first message are different.

In one embodiment, RBs (Resource Blocks) occupied by any two uplink grants configured by the first message are the same.

In one embodiment, RBs occupied by any two uplink grants configured by the first message are different.

In one embodiment, the configuration cycle is a configuration cycle of a CG.

In one embodiment, the configuration cycle is a configuration cycle in a CG configuration.

In one embodiment, any two uplink grants configured by the first message do not comprise same time-domain resources.

In one embodiment, any two uplink grants configured by the first message are not allocated same time-domain resources.

In one embodiment, any two uplink grants configured by the first message do not comprise a same symbol.

In one embodiment, any symbol belongs to any two uplink grants configured by the first message not at the same time.

In one embodiment, for two adjacent uplink grants configured by the first message, an end time of an uplink grant earlier in time domain is earlier than a start time of an uplink grant later in time domain.

In one embodiment, for two adjacent uplink grants configured by the first message, at least one symbol is comprised between an end time of an uplink grant earlier in time domain and a start time of an uplink grant later in time domain.

In one embodiment, for two adjacent uplink grants configured by the first message, no symbol is comprised between an end time of an uplink grant earlier in time domain and a start time of an uplink grant later in time domain.

In one embodiment, any two uplink grants configured by the first message being non-overlapping in time refers to: PUSCH durations of any two uplink grants configured by the first message are non-overlapping in time.

In one embodiment, a position of the first control information on a corresponding PUSCH corresponding to the first uplink grant is predefined.

In one embodiment, a position of the first control information on a PUSCH corresponding to the first uplink grant is RRC-configured.

In one embodiment, a position of the first control information on a PUSCH corresponding to the first uplink grant is calculated.

In one embodiment, the first control information is transmitted in a physical-layer channel.

In one embodiment, the first control information is multiplexed in a physical-layer channel.

In one embodiment, the first control information is transmitted on a PUSCH.

In one embodiment, the first control information occupies PUSCH resources.

In one embodiment, the first control information occupies PUSCH resources of the first uplink grant.

In one embodiment, the first control information is partial bits in a PUSCH transmission.

In one embodiment, the first control information is a UCI (Uplink Control Information).

In one embodiment, the first control information is a CG-UCI.

In one embodiment, the first control information is an Unused Transmission Occasion (UTO)-UCI.

In one embodiment, a number of bit(s) occupied by the first control information is fixed.

In one embodiment, a number of bit(s) occupied by the first control information is configurable.

In one embodiment, a number of bit(s) occupied by the first control information is pre-defined.

In one embodiment, a number of bit(s) occupied by the first control information is fixed.

In one embodiment, a number of bit(s) occupied by the first control information is default.

In one embodiment, unused/not unused refers to: unused/used.

In one embodiment, unused/not unused refers to: won't be use/will be used.

In one embodiment, unused/not unused refers to: no need to keep/need to keep.

In one embodiment, unused/not unused refers to: not needed/needed.

In one embodiment, unused/not unused refers to: unused/not unused.

In one embodiment, unused/not unused refers to: unused/used.

In one embodiment, control information comprises a bitmap, and any bit in the bitmap corresponds to an uplink grant.

In one subembodiment of the embodiment, if a bit in the bitmap in the control information is set to 1, the control information indicates that an uplink grant corresponding to the bit is unused; if a bit in the bitmap in the control information is set to 0, the control information indicates that an uplink grant corresponding to the bit is not unused.

In one subembodiment of the embodiment, if a bit in the bitmap in the control information is set to 0, the control information indicates that an uplink grant corresponding to the bit is unused; if a bit in the bitmap in the control information is set to 1, the control information indicates that an uplink grant corresponding to the bit is not unused.

In one embodiment, the target uplink grant is later than the first uplink grant in time domain.

In one embodiment, time-domain resources allocated to the target uplink are later than time-domain resources allocated to the first uplink.

In one embodiment, the target uplink grant is an uplink grant after the first uplink grant.

In one embodiment, the target uplink grant is an uplink grant immediately following the first uplink grant.

In one embodiment, the target uplink grant is any uplink grant after the first uplink grant.

In one embodiment, the target uplink grant is an uplink grant indicated by the first control information after the first uplink grant.

In one embodiment, the target uplink grant is any uplink grant indicated by the first control information after the first uplink grant.

In one embodiment, the target uplink grant is any uplink grant belonging to a same configuration cycle after the first uplink grant.

In one embodiment, the target uplink grant is an uplink grant belonging to different configuration cycles after the first uplink grant.

In one embodiment, the target uplink grant is any uplink grant in at most NI configuration cycles after the first uplink grant.

In one embodiment, only when the first condition set is met, a candidate for an indication of the first control information for the target uplink grant comprises the unused and the not unused.

In one embodiment, when the first condition set is not met, a candidate for an indication of the first control information for the target uplink grant comprises only one of the unused and the not unused.

In one subembodiment of the embodiment, when the first condition set is not met, an indication of the first control information for the target uplink grant can only be the only one of the unused and the not unused.

In one subembodiment of the embodiment, the only one of the unused and the not unused is: only a former of the unused and the not unused.

In one subembodiment of the embodiment, the only one of the unused and the not unused is: only a latter of the unused and the not unused.

In one subembodiment of the embodiment, the only one of the unused and the not unused is: the unused.

In one subembodiment of the embodiment, the only one of the unused and the not unused is: the not unused.

In one embodiment, when the first condition set is met, a candidate for an indication of the first control information for the target uplink grant comprises the unused and the not unused; when the first condition set is not met, a candidate for an indication of the first control information for the target uplink grant comprises the only one of the unused and the not unused.

In one embodiment, if a candidate for an indication of the first control information for the target uplink grant comprises unused and not unused, whether an indication of the first control information for the target uplink grant is unused or not unused is determined based on a condition outside the first condition set.

In one embodiment, if a candidate for an indication of the first control information for the target uplink grant comprises the only one of the unused and the not unused, regardless of whether a condition outside the first condition set is met, an indication of the first control information for the target uplink grant can only be the only of the unused and the not unused.

In one embodiment, the symbol is a single carrier symbol.

In one embodiment, the symbol is a multicarrier symbol.

In one embodiment, the symbol is an Orthogonal Frequency Division Multiplexing (OFDM) symbol.

In one embodiment, the symbol is a Single Carrier-Frequency Division Multiple Access (SC-FDMA) symbol.

In one embodiment, the symbol is a Discrete Fourier Transform Spread OFDM (DFT-S-OFDM) symbol.

In one embodiment, the symbol is a Filter Bank Multi-Carrier (FBMC) symbol.

In one embodiment, the overlapping refers to overlap.

In one embodiment, the overlapping refers to fully overlapping.

In one embodiment, the overlapping refers to partially overlapping.

In one embodiment, the overlapping refers to at least partially overlapping.

In one embodiment, the overlapping refers to non-orthogonal.

In one embodiment, the overlapping refers to comprise same time-domain resources.

In one embodiment, the non-overlapping refers to orthogonal.

In one embodiment, the non-overlapping refers to not comprise same time-domain resources.

In one embodiment, an indication of the first control information for the target uplink grant is set as either the unused or the not unused based on a condition outside the first condition set.

In one embodiment, a condition outside the first condition set is related to at least data volume; the first condition set is unrelated to data volume.

### Embodiment 2

Embodiment 2 illustrates a schematic diagram of a network architecture according to one embodiment of the present application, as shown in FIG. 2. FIG. 2 illustrates the network architecture 200 of 5G NR (New Radio)/LTE (Long Term Evolution)/LTE-A (Long Term Evolution Advanced) system. The 5G NR/LTE/LTE-A network architecture 200 may be called a 5G System (5GS)/Evolved Packet System (EPS) 200 or other appropriate terms. 5GS/EPS 200 includes at least one of UE (User Equipment) 201, RAN (Wireless Access Network) 202, 5GC (5G Core Network)/EPC (Evolved Packet Core) 210, HSS (Home Subscription Server)/UDM (Unified Data Management) 220 or Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The RAN comprises the node 203 and other nodes 204. The node 203 provides UE 201-oriented user plane and control plane protocol terminations. The node 203 may be connected to other nodes 204 via an Xn interface (e.g., backhaul)/X2 interface. The node 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The node 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy; a mobile client, a client or some other appropriate terms. The node 203 is connected to the 5GC/EPC 210 via an SI/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 is a UE.

In one embodiment, the node 203 corresponds to the second node in the present application.

In one embodiment, the node 203 is a BaseStation (BS).

In one embodiment, the node 203 is a Base Transceiver Station (BTS).

In one embodiment, the node 203 is a NodeB (NB).

In one embodiment, the node 203 is a gNB.

In one embodiment, the node 203 is an eNB.

In one embodiment, the node 203 is a ng-eNB.

In one embodiment, the node 203 is an en-gNB.

In one embodiment, the node 203 is a Centralized Unit (CU).

In one embodiment, the node 203 is a Distributed Unit (DU).

In one embodiment, the node 203 is a UE.

In one embodiment, the node 203 is a relay.

In one embodiment, the node 203 is a gateway.

In one embodiment, the UE supports Terrestrial Network (TN) transmission.

In one embodiment, the UE supports Non-Terrestrial Network (NTN) transmission.

In one embodiment, the UE supports transmission within networks with large latency differences.

In one embodiment, the UE supports Dual Connection (DC) transmission.

In one embodiment, the UE comprises an aircraft.

In one embodiment, the UE comprises a vehicle terminal.

In one embodiment, the UE comprises a vessel.

In one embodiment, the UE comprises an Internet of Things (IoT) terminal.

In one embodiment, the UE comprises an Industrial Internet of Things (IIoT) terminal.

In one embodiment, the UE comprises a device supporting transmission with low-latency and high-reliability:

In one embodiment, the UE comprises test equipment.

In one embodiment, the UE comprises a signaling tester.

In one embodiment, the base station supports transmission over a non-terrestrial network.

In one embodiment, the base station supports transmission over networks with large latency differences.

In one embodiment, the base station supports transmission over a terrestrial network.

In one embodiment, the base station comprises a Marco Cellular base station.

In one embodiment, the base station comprises a Micro Cell base station.

In one embodiment, the base station comprises a Pico Cell base station.

In one embodiment, the base station comprises a Femtocell.

In one embodiment, the base station comprises a base station supporting large latency differences.

In one embodiment, the base station comprises flight platform equipment.

In one embodiment, the base station comprises satellite equipment.

In one embodiment, the base station comprises a Transmitter Receiver Point (TRP).

In one embodiment, the base station comprises a CU.

In one embodiment, the base station comprises a DU.

In one embodiment, the base station comprises test equipment.

In one embodiment, the base station comprises a signaling tester.

In one embodiment, the base station comprises an Integrated Access and Backhaul (IAB)-node.

In one embodiment, the base station comprises an IAB-donor.

In one embodiment, the base station comprises an IAB-donor-CU.

In one embodiment, the base station comprises an IAB-donor-DU.

In one embodiment, the base station comprises an IAB-DU.

In one embodiment, the base station comprises an IAB-MT.

In one embodiment, the relay comprises a relay:

In one embodiment, the relay comprises an L3 relay.

In one embodiment, the relay comprises an L2 relay.

In one embodiment, the relay comprises a router.

In one embodiment, the relay comprises a switch.

In one embodiment, the relay comprises a UE.

In one embodiment, the relay comprises a base station.

### Embodiment 3

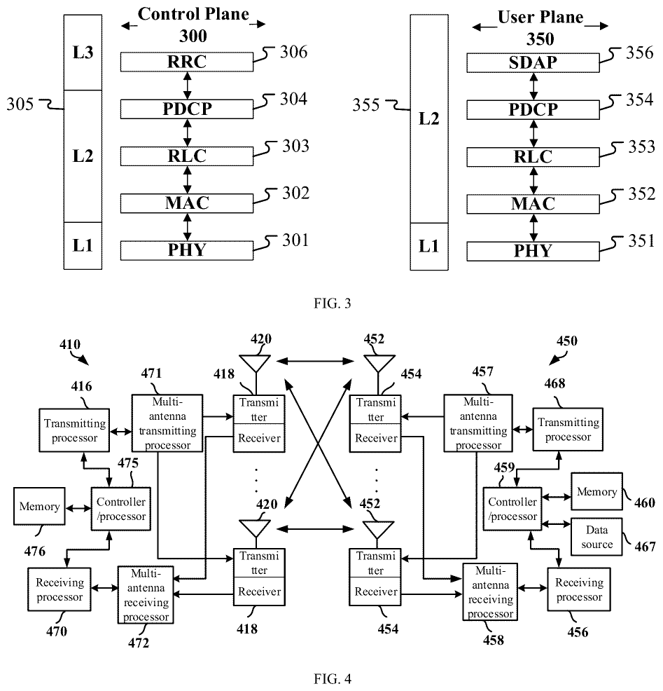

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for the control plane 300 is represented by three layers, which are a layer 1, a layer 2 and a layer 3, respectively. The layer 1 (L1) is the lowest layer and performs signal processing functions of various PHY layers. The L1 is called PHY 301 in the present application. Layer 2 (L2) 305 is above PHY 301 and includes MAC (Medium Access Control) sublayer 302, RLC (Radio Link Control Protocol) sublayer 303, and PDCP (Packet Data Convergence Protocol) sublayer 304. The PDCP sublayer 304 provides multiplexing among variable radio bearers and logical channels. The PDCP sublayer 304 provides security by encrypting a data packet and provides support for handover. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating various radio resources (i.e., resources block) in a cell. The MAC sublayer 302 is also in charge of HARQ operation. The RRC sublayer 306 in L3 layer of the control plane 300 is responsible for acquiring radio resources (i.e., radio bearer) and configuring the lower layer with an RRC signaling. The radio protocol architecture of the user plane 350 comprises layer 1 (L1) and layer 2 (L2). In the user plane 350, the radio protocol architecture is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic.

In one embodiment, the radio protocol architecture in FIG. 3 is applicable to the first node in the present application.

In one embodiment, the radio protocol architecture in FIG. 3 is applicable to the second node in the present application.

In one embodiment, the first message in the present application is generated by the RRC 306.

In one embodiment, the first message in the present application is generated by the MAC 302 or the MAC 352.

In one embodiment, the first message in the present application is generated by the PHY 301 or the PHY 351.

In one embodiment, the second message in the present application is generated by the RRC 306.

In one embodiment, the second message in the present application is generated by the MAC 302 or the MAC 352.

In one embodiment, the second message in the present application is generated by the PHY 301 or the PHY 351.

In one embodiment, the first control information in the present application is generated by the RRC 306.

In one embodiment, the first control information in the present application is generated by the MAC 302 or the MAC 352.

In one embodiment, the first control information in the present application is generated by the PHY 301 or the PHY 351.

In one embodiment, the second control information in the present application is generated by the RRC 306.

In one embodiment, the second control information in the present application is generated by the MAC 302 or the MAC 352.

In one embodiment, the second control information in the present application is generated by the PHY 301 or the PHY 351.

In one embodiment, the first signaling in the present application is generated by the RRC 306.

In one embodiment, the first signaling in the present application is generated by the MAC 302 or the MAC 352.

In one embodiment, the first signaling in the present application is generated by the PHY 301 or the PHY 351.

### Embodiment 4

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410 side, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises at least one processor and at least one memory, at least one processor and at least one memory. The at least one memory comprises computer program codes; the at least one memory and the computer program codes are configured to be used in collaboration with the at least one processor, the first communication device 450 at least: receives a first message, the first message is configured with an uplink grant, and any two uplink grants configured by the first message are non-overlapping in time; transmits first control information in a first uplink grant, the first control information indicates whether a target uplink grant is unused, the first uplink grant and the target uplink grant are configured by the first message, the target uplink grant is after the first uplink grant; herein, a candidate for an indication of the first control information for the target uplink grant depends on a first condition set; the phrase that a candidate for an indication of the first control information for the target uplink grant depends on a first condition set comprises: when the first condition set is met, a candidate for an indication of the first control information for the target uplink grant comprises unused and not unused.

In one embodiment, the first communication device 450 comprises at least one processor and at least one memory, a memory that stores a computer readable instruction program. The computer readable instruction program generates an action when executed by at least one processor. The action includes: receiving a first message, the first message being configured with an uplink grant, and any two uplink grants configured by the first message being non-overlapping in time; transmitting first control information in a first uplink grant, the first control information indicating whether a target uplink grant is unused, the first uplink grant and the target uplink grant being configured by the first message, the target uplink grant being after the first uplink grant; herein, a candidate for an indication of the first control information for the target uplink grant depends on a first condition set; the phrase that a candidate for an indication of the first control information for the target uplink grant depends on a first condition set comprises: when the first condition set is met, a candidate for an indication of the first control information for the target uplink grant comprises unused and not unused.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: transmits a first message, the first message is configured with an uplink grant, and any two uplink grants configured by the first message are non-overlapping in time; receives first control information, the first control information indicates whether a target uplink grant is unused, a first uplink grant and the target uplink grant are configured by the first message, the target uplink grant is after the first uplink grant; herein, a receiver of the first message transmits the first control information in the first uplink grant; a candidate for an indication of the first control information for the target uplink grant depends on a first condition set; the phrase that a candidate for an indication of the first control information for the target uplink grant depends on a first condition set comprises: when the first condition set is met, a candidate for an indication of the first control information for the target uplink grant comprises unused and not unused.

In one embodiment, the second communication device 410 comprises a memory that stores a computer readable instruction program. The computer readable instruction program generates an action when executed by at least one processor. The action includes: transmitting a first message, the first message being configured with an uplink grant, and any two uplink grants configured by the first message being non-overlapping in time; receiving first control information, the first control information indicating whether a target uplink grant is unused, a first uplink grant and the target uplink grant being configured by the first message, the target uplink grant being after the first uplink grant; herein, a receiver of the first message transmits the first control information in the first uplink grant; a candidate for an indication of the first control information for the target uplink grant depends on a first condition set; the phrase that a candidate for an indication of the first control information for the target uplink grant depends on a first condition set comprises: when the first condition set is met, a candidate for an indication of the first control information for the target uplink grant comprises unused and not unused.

In one embodiment, at least one of the antenna 452, the receiver 454, the receiving processor 456, or the controller/processor 459 is used to receive a first message.

In one embodiment, at least one of the antenna 420, the transmitter 418, the transmitting processor 416, or the controller/processor 475 is used to transmit a first message.

In one embodiment, at least one of the antenna 452, the receiver 454, the receiving processor 456, or the controller/processor 459 is used to receive a second message.

In one embodiment, at least one of the antenna 420, the transmitter 418, the transmitting processor 416, or the controller/processor 475 is used to transmit a second message.

In one embodiment, at least one of the antenna 452, the receiver 454, the receiving processor 456, or the controller/processor 459 is used to receive a first signaling.

In one embodiment, at least one of the antenna 420, the transmitter 418, the transmitting processor 416, or the controller/processor 475 is used to transmit a first signaling.

In one embodiment, at least one of the antenna 452, the transmitter 454, the transmitting processor 468, or the controller/processor 459 is used to transmit first control information.

In one embodiment, at least one of the antenna 420, the receiver 418, the receiving processor 470, or the controller/processor 475 is used to receive first control information.

In one embodiment, at least one of the antenna 452, the transmitter 454, the transmitting processor 468, or the controller/processor 459 is used to transmit second control information.

In one embodiment, at least one of the antenna 420, the receiver 418, the receiving processor 470, or the controller/processor 475 is used to receive second control information.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a base station.

In one embodiment, the first communication device 450 is a relay.

In one embodiment, the second communication device 410 is a UE.

In one embodiment, the second communication device 410 is a base station.

In one embodiment, the second communication device 410 is a relay.

### Embodiment 5

Embodiment 5 illustrates a flowchart of radio signal transmission according to one embodiment in the present application, as shown in FIG. 5. It is particularly underlined that the order illustrated in the embodiment does not put constraints over sequences of signal transmissions and implementations.

The first node U01 receives a first message in step S5101, the first message is configured with an uplink grant, and any two uplink grants configured by the first message are non-overlapping in time; in step S5102, receives a second message, the second message indicates a first symbol set; in step S5103, transmits second control information in a second uplink grant, the second uplink grant is configured by the first message, and the second uplink grant is prior to the first uplink grant; receives a first signaling in step S5104; in step S5105, transmits first control information in a first uplink grant, the first control information indicates whether a target uplink grant is unused, the first uplink grant and the target uplink grant are configured by the first message, and the target uplink grant is after the first uplink grant.

The second node N02, transmits the first message in step S5201; transmits the second message in step S5202; receives the second control information in step S5203; transmits the first signaling in step S5204; receives the first control information in step S5205.

In embodiment 5, a candidate for an indication of the first control information for the target uplink grant depends on a first condition set; the phrase that a candidate for an indication of the first control information for the target uplink grant depends on a first condition set comprises: when the first condition set is met, a candidate for an indication of the first control information for the target uplink grant comprises unused and not unused.

In one embodiment, the first node U01 is a UE.

In one embodiment, the first node U01 is a base station.

In one embodiment, the first node U01 is a relay device.

In one embodiment, the second node N02 is a base station.

In one embodiment, the second node N02 is a UE.

In one embodiment, the second node N02 is a relay device.

In one embodiment, the second node N02 is a Master Node (MN).

In one embodiment, the second node N02 is an SN (secondary node).

In one embodiment, the second node N02 is a maintenance base station for a serving cell of the first node.

In one embodiment, the first node U01 is a UE, and the second node N02 is a base station.

In one embodiment, the first node U01 is a UE, and the second node N02 is a UE.

In one embodiment, the first node U01 is a base station, and the second node N02 is a base station.

In one embodiment, the second control information is transmitted in a physical-layer channel.

In one embodiment, the second control information is multiplexed in a physical-layer channel.

In one embodiment, the second control information is transmitted on a PUSCH.

In one embodiment, the second control information occupies PUSCH resources.

In one embodiment, the second control information occupies PUSCH resources of the first uplink grant.

In one embodiment, the second control information is partial bits in a PUSCH transmission.

In one embodiment, the second control information is a UCI.

In one embodiment, the second control information is a CG-UCI.

In one embodiment, the second control information is a UTO-UCI.

In one embodiment, a number of bit(s) occupied by the second control information is fixed.

In one embodiment, a number of bit(s) occupied by the second control information is configurable.

In one embodiment, a number of bit(s) occupied by the second control information is pre-defined.

In one embodiment, a number of bit(s) occupied by the second control information is fixed.

In one embodiment, a number of bit(s) occupied by the second control information is default.

In one embodiment, the second uplink grant is one of uplink grants configured by the first message.

In one embodiment, the second uplink grant is earlier than the first uplink grant in time domain.

In one embodiment, time-domain resources allocated to the second uplink are earlier than time-domain resources allocated to the first uplink.

In one embodiment, the second uplink grant is an uplink grant prior to the first uplink grant.

In one embodiment, the first uplink grant is an uplink grant immediately following the first uplink grant.

In one embodiment, the second uplink grant is any uplink grant prior to the first uplink grant.

In one embodiment, the second uplink grant and the first uplink grant belong to a same configuration cycle.

In one embodiment, the second uplink grant and the first uplink grant belong to different configuration cycles.

In one embodiment, the second uplink grant and the target uplink grant belong to a same configuration cycle.

In one embodiment, the second uplink grant and the target uplink grant belong to different configuration cycles.

In one embodiment, the dotted box F5.1 is optional.

In one embodiment, the first condition set comprises that the target uplink grant and the first symbol set are non-overlapping; the dotted box F5.1 exists.

In one subembodiment of the embodiment, if the target uplink grant and the first symbol set are non-overlapping, the first condition set is met.

In one subembodiment of the embodiment, if at least the target uplink grant and the first symbol set are non-overlapping, the first condition set is met.

In one subembodiment of the embodiment, if the target uplink grant and the first symbol set are overlapping, the first condition set is not met.

In one subembodiment of the embodiment, only when the target uplink grant and the first symbol set are non-overlapping, a candidate for an indication of the first control information for the target uplink grant comprises unused and not unused.

In one subembodiment of the embodiment, when the target uplink grant and the first symbol set are non-overlapping, a candidate for an indication of the first control information for the target uplink grant comprises unused and not unused; when the target uplink grant and the first symbol set are overlapping, a candidate for an indication of the first control information for the target uplink grant comprises only a former of unused and not unused.

In one subembodiment of the embodiment, the second message is an RRC message.

In one subembodiment of the embodiment, the second message configures the first symbol set.

In one subembodiment of the embodiment, the second message is used to determine the first symbol set.

In one subembodiment of the above embodiment, the first symbol set is at least one symbol.

In one subembodiment of the above embodiment, the first symbol set is continuous at least one symbol in time domain.

In one subembodiment of the above embodiment, the first symbol set is continuous multiple symbols in time domain.

In one subembodiment of the above embodiment, the first symbol set is all symbols in a slot.

In one subembodiment of the above embodiment, the first symbol set is partial symbols in a slot.

In one subembodiment of the above embodiment, the first symbol set belongs to a same slot.

In one subembodiment of the above embodiment, the first symbol set belongs to at least one slot.

In one subembodiment of the above embodiment, the first symbol set belongs to multiple slots.

In one subembodiment of the above embodiment, the first symbol set is discontinuous in time domain.

In one subembodiment of the above embodiment, whether the first symbol set is continuous in time domain is configurable.

In one subembodiment of the above embodiment, the first symbol set is time-domain resources configured by the second message.

In one subembodiment of the above embodiment, the first symbol set is time-domain resources indicated by the second message.

In one subembodiment of the above embodiment, the first symbol set is time-domain resources determined by the second message.

In one subembodiment of the above embodiment, the first symbol set is time-domain resources activated by the second message.

In one subembodiment of the above embodiment, the first symbol set is time-domain resources configured and activated by the second message.

In one subembodiment of the above embodiment, the first symbol set is time-domain resources configured and indicated by the second message.

In one subembodiment of the above embodiment, the first symbol set is time-domain resources corresponding to a time-frequency resource allocated to sidelink.

In one subembodiment of the above embodiment, the above method reduces the impact on sidelink communications.

In one subembodiment of the above embodiment, the first symbol set is time-domain resources allocated to a candidate uplink grant.

In one subembodiment of the above embodiment, the first symbol set is an activated measurement gap.

In one subembodiment of the above embodiment, the first symbol set is indicated by the second message in time-domain resource for downlink transmission.

In one subembodiment of the above embodiment, the first symbol set is used for network power saving.

In one subembodiment of the above embodiment, the first symbol set is an inactive time of cell DRX (Discontinuous Reception)/DTX (Discontinuous Transmission).

In one subembodiment of the embodiment, the phrase that the target uplink grant and the first symbol set are non-overlapping refers to: a PUSCH duration of the target uplink grant and the first symbol set are non-overlapping.

In one subembodiment of the embodiment, the phrase that the target uplink grant and the first symbol set are non-overlapping refers to: any symbol of the target uplink grant in time domain and the first symbol set are non-overlapping.

In one subembodiment of the embodiment, the phrase that the target uplink grant and the first symbol set are non-overlapping refers to: any symbol of the target uplink grant in time domain does not belong to the first symbol set.

In one subembodiment of the embodiment, the phrase that the target uplink grant and the first symbol set are non-overlapping refers to: the target uplink grant and the first symbol set do not comprise any same time-domain resource.

In one subembodiment of the embodiment, the phrase that the target uplink grant and the first symbol set are non-overlapping refers to: the target uplink grant and the first symbol set are not allocated any same time-domain resource.

In one subembodiment of the embodiment, the phrase that the target uplink grant and the first symbol set are overlapping refers to: a PUSCH duration of the target uplink grant and the first symbol set are overlapping.

In one subembodiment of the embodiment, the phrase that the target uplink grant and the first symbol set are overlapping refers to: the target uplink grant and the first symbol set are fully overlapping in time domain.

In one subembodiment of the embodiment, the phrase that the target uplink grant and the first symbol set are overlapping refers to: the target uplink grant and the first symbol set are partially overlapping in time domain.

In one subembodiment of the embodiment, the phrase that the target uplink grant and the first symbol set are overlapping refers to: at least one symbol of the target uplink grant in time domain and the first symbol set are overlapping.

In one subembodiment of the embodiment, the phrase that the target uplink grant and the first symbol set are overlapping refers to: any symbol of the target uplink grant in time domain belongs to the first symbol set.

In one subembodiment of the embodiment, the phrase that the target uplink grant and the first symbol set are overlapping refers to: the target uplink grant and the first symbol comprise at least one same time-domain resource.

In one subembodiment of the embodiment, the phrase that the target uplink grant and the first symbol set are overlapping refers to: a PUSCH duration of the target uplink grant belongs to the first symbol set.

In one subembodiment of the embodiment, the phrase that the target uplink grant and the first symbol set are overlapping refers to: the first symbol set belongs to a PUSCH duration of the target uplink grant.

In one subembodiment of the above embodiment, the first symbol set is a time while a timer is running.

In one subembodiment of the above embodiment, the first symbol set is a time while a ra-Response Window is running.

In one subembodiment of the above embodiment, the first symbol set is a time while a msgB-Response Window is running.

In one subembodiment of the embodiment, the first symbol set is a time while a ra-ContentionResolutionTimer is running.

In one embodiment, the dotted box F5.1 does not exist.

In one embodiment, the dotted box F5.2 is optional.

In one embodiment, the dotted box F5.2 exists.

In one embodiment, the first condition set comprises that the second control information indicates that the target uplink grant is not unused; the second control information indicates whether the target uplink grant is unused; the dotted box F5.2 exists.

In one subembodiment of the embodiment, when the second control information indicates that the target uplink grant is not unused, a candidate for an indication of the first control information for the target uplink grant comprises unused and not unused.

In one subembodiment of the embodiment, when at least the second control information indicates that the target uplink grant is not unused, a candidate for an indication of the first control information for the target uplink grant comprises unused and not unused.

In one subembodiment of the embodiment, only when the second control information indicates that the target uplink grant is not unused, a candidate for an indication of the first control information for the target uplink grant comprises unused and not unused.

In one subembodiment of the embodiment, when the second control information indicates that the target uplink grant is unused, a candidate for an indication of the first control information for the target uplink grant comprises only a former of unused and not unused.

In one subembodiment of the embodiment, when the second control information indicates that the target uplink grant is not unused, a candidate for an indication of the first control information for the target uplink grant comprises unused and not unused; when the second control information indicates that the target uplink grant is unused, a candidate for an indication of the first control information for the target uplink grant comprises only a former of unused and not unused.

In one subembodiment of the embodiment, a bit corresponding to the target uplink grant in a bitmap comprised in the second control information indicates whether the target uplink grant is unused.

In one subembodiment of the embodiment, a bit in the second control information indicates whether the target uplink grant is unused.

In one subembodiment of the embodiment, the second control information is used to determine whether the target uplink grant is unused.

In one subembodiment of the embodiment, the second control information indicates that the target uplink grant is unused, and the first condition set is met.

In one subembodiment of the embodiment, the second control information indicates that the target uplink grant is not unused, and the first condition set is not met.

In one embodiment, the first condition set comprises that a first signaling is not received; the second control information triggers the first signaling; the second control information indicates that the target uplink grant is unused; the dotted box F5.2 exists.

In one subembodiment of the embodiment, when the first signaling is not received, a candidate for an indication of the first control information for the target uplink grant comprises unused and not unused.

In one subembodiment of the embodiment, only when the first signaling is not received, a candidate for an indication of the first control information for the target uplink grant comprises unused and not unused.

In one subembodiment of the embodiment, when at least the first signaling is not received, a candidate for an indication of the first control information for the target uplink grant comprises unused and not unused.

In one subembodiment of the embodiment, when the first signaling is received, a candidate for an indication of the first control information for the target uplink grant comprises only a former of unused and not unused.

In one subembodiment of the embodiment, when the first signaling is not received, a candidate for an indication of the first control information for the target uplink grant comprises unused and not unused; when the first signaling is received, a candidate for an indication of the first control information for the target uplink grant comprises only a former of unused and not unused.

In one embodiment, the first condition set comprises that a first time interval reaches a first threshold; the first time interval is related to two of the first uplink grant or the second uplink grant or the target uplink grant; the second control information indicates that the target uplink grant is unused; the dotted box F5.2 exists.

In one subembodiment of the embodiment, when the first time interval reaches the first threshold, a candidate for an indication of the first control information for the target uplink grant comprises unused and not unused.

In one subembodiment of the embodiment, only when the first time interval reaches the first threshold, a candidate for an indication of the first control information for the target uplink grant comprises unused and not unused.

In one subembodiment of the embodiment, when at least the first time interval reaches the first threshold, a candidate for an indication of the first control information for the target uplink grant comprises unused and not unused.

In one subembodiment of the embodiment, when the first time interval does not reach the first threshold, a candidate for an indication of the first control information for the target uplink grant comprises only a former of unused and not unused.

In one subembodiment of the embodiment, when the first time interval reaches the first threshold, a candidate for an indication of the first control information for the target uplink grant comprises unused and not unused; when the first time interval does not reach the first threshold, a candidate for an indication of the first control information for the target uplink grant comprises only a former of unused and not unused.

In one subembodiment of the above embodiment, the first time interval is a time interval between the first uplink grant and the second uplink grant.

In one subembodiment of the above embodiment, the first time interval is a time interval between the first uplink grant and the target uplink grant.

In one subembodiment of the above embodiment, the first time interval is a time interval between the second uplink grant and the target uplink grant.

In one subembodiment of the embodiment, the first time interval reaching the first threshold refers to: the first time interval is not less than the first threshold; the first time interval not reaching the first threshold refers to: the first time interval is less than the first threshold.

In one subembodiment of the embodiment, the first time interval reaching the first threshold refers to:

the first time interval is greater than the first threshold; the first time interval not reaching the first threshold refers to: the first time interval is not greater than the first threshold.

In one subembodiment of the embodiment, the first time interval reaching the first threshold refers to: the first time interval is less than the first threshold; the first time interval not reaching the first threshold refers to: the first time interval is not less than the first threshold.

In one subembodiment of the embodiment, the first time interval reaching the first threshold refers to: the first time interval is greater than the first threshold; the first time interval not reaching the first threshold refers to: the first time interval is greater than the first threshold.

In one subembodiment of the embodiment, a timer is used to determine the first timer interval; the first time interval reaching the first threshold refers to: the timer expires; the first time interval not reaching the first threshold refers to: the timer is running.

In one subembodiment of the embodiment, the first threshold is configurable.

In one subembodiment of the embodiment, the first threshold is RRC-configured.

In one subembodiment of the embodiment, the first threshold is at least one symbol.

In one subembodiment of the embodiment, the first threshold is at least one slot.

In one subembodiment of the embodiment, the first threshold is a positive integer number of uplink grant time interval(s).

In one subembodiment of the embodiment, the uplink grant time interval is a time interval between two adjacent uplink grants configured by the first message.

In one embodiment, the dotted box F5.2 does not exist.

In one embodiment, the dotted box F5.3 is optional.

In one embodiment, the dotted box F5.3 exists; the dotted box F5.2 exists.

In one subembodiment of the embodiment, the first signaling is received; the first condition set is not met, a candidate for an indication of the first control information for the target uplink grant comprises only a former of unused and the not unused; the first condition set comprises that the first signaling is not received; the second control information triggers the first signaling; the second control information indicates that the target uplink grant is unused.

In one embodiment, the dotted box F5.3 does not exist; the dotted box F5.2 exists.

In one subembodiment of the embodiment, the first signaling is not received; the first condition set is met, and a candidate for an indication of the first control information for the target uplink grant comprises unused and not unused; the first condition set comprises that the first signaling is not received; the second control information triggers the first signaling; the second control information indicates that the target uplink grant is unused.

In one embodiment, the dotted box F5.3 does not exist; the dotted box F5.2 does not exist.

In one embodiment, the first condition set comprises only one condition.

In one embodiment, the first condition set comprises at least one condition.

In one embodiment, the first condition set comprises multiple conditions.

In one embodiment, the first condition set comprises that at least the target uplink grant and the first symbol set are non-overlapping.

In one embodiment, the first condition set comprises that at least the second control information indicates that the target uplink grant is not unused.

In one embodiment, the first condition set comprises that at least a first signaling is not received.

In one embodiment, the first condition set comprises that at least a first time interval reaches a first threshold.

In one embodiment, the first condition set comprises that the target uplink is not indicated by control information prior to the first control information.

In one embodiment, the first condition set comprises at least one of the target uplink grant and the first symbol set being non-overlapping or the second control information indicating that the target uplink grant is not unused or the first signaling not being received or a first time interval reaching a first threshold or the target uplink grant not being indicated by control information prior to the first control information.

In one embodiment, if each condition in the first condition set is met, the first condition set is met; if any condition in the first condition set is not met, the first condition set is not met.

In one embodiment, the first condition set comprises that the target uplink grant and the first symbol are non-overlapping and the second control information indicates that the target uplink grant is not unused; if the target uplink grant and the first symbol set are non-overlapping and the second control information indicates that the target uplink grant is not unused, the first condition set is met; if the target uplink grant and the first symbol set are overlapping or the second control information indicates that the target uplink grant is unused, the first condition set is not met.

In one embodiment, the first condition set comprises that a first signaling is not received and a first time interval reaches a first threshold; if a first signaling is not received and a first time interval reaches a first threshold, the first condition set is met; if a first signaling is received or a first time interval does not reach a first threshold, the first condition set is not met.

### Embodiment 6

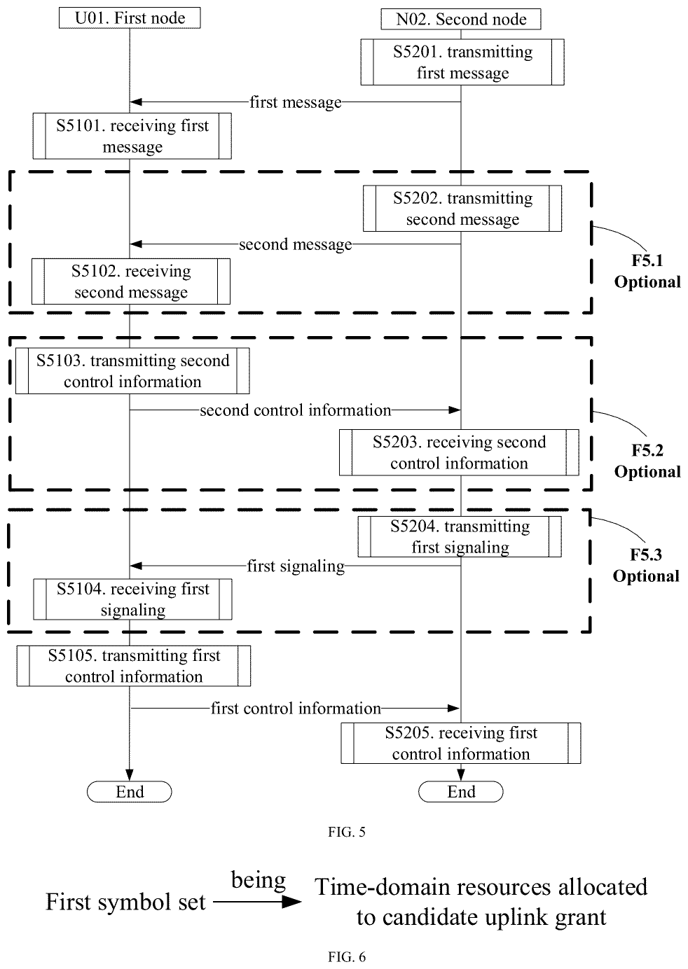

Embodiment 6 illustrate a schematic diagram of a first symbol set being time-domain resources allocated to a candidate uplink grant according to one embodiment of the present application, as shown in FIG. 6.

In embodiment 6, the first symbol set is time-domain resources allocated to a candidate uplink grant.

In one embodiment, the first symbol set is a PUSCH duration allocated to a candidate uplink grant.

In one embodiment, the candidate uplink grant is addressed to Temporary C-RNTI.

In one embodiment, the above methods reduce the impact on random access.

In one embodiment, the candidate uplink grant is dynamically received on a PDCCH.

In one embodiment, the candidate uplink grant is received in a Random Access Response (RAR).

In one embodiment, the above methods reduce the impact on random access.

In one embodiment, the candidate uplink grant is configured semi-persistently by RRC.

In one embodiment, the candidate uplink grant is determined based on PUSCH resources associated with MSGA (Message A).

In one embodiment, the above methods reduce the impact on random access.

In one embodiment, the candidate uplink grant is a DG (Dynamic Grant).

In one embodiment, the above methods reduce the impact on dynamically-scheduled uplink grants.

In one embodiment, the candidate uplink grant is a CG; the CG is not an uplink grant in uplink grants configured by the first message.

In one embodiment, a priority of the candidate uplink grant is higher than a priority of the target uplink grant.

In one embodiment, the above methods reduce the impact on an uplink grant with higher priority.

In one embodiment, a MAC entity is configured with Ich-basedPrioritization.

In one embodiment, a MAC entity is not configured with Ich-basedPrioritization.

In one embodiment, a MAC entity is configured with Ich-basedPrioritization; the candidate uplink grant is addressed to a Temporary C-RNTI, or is received in a random access response, or is associated with an MSGA payload.

In one embodiment, a MAC entity is not configured with Ich-basedPrioritization; the candidate uplink grant is dynamically received on a PDCCH, or is received in a random access response, or is associated with an MSGA payload.

### Embodiment 7

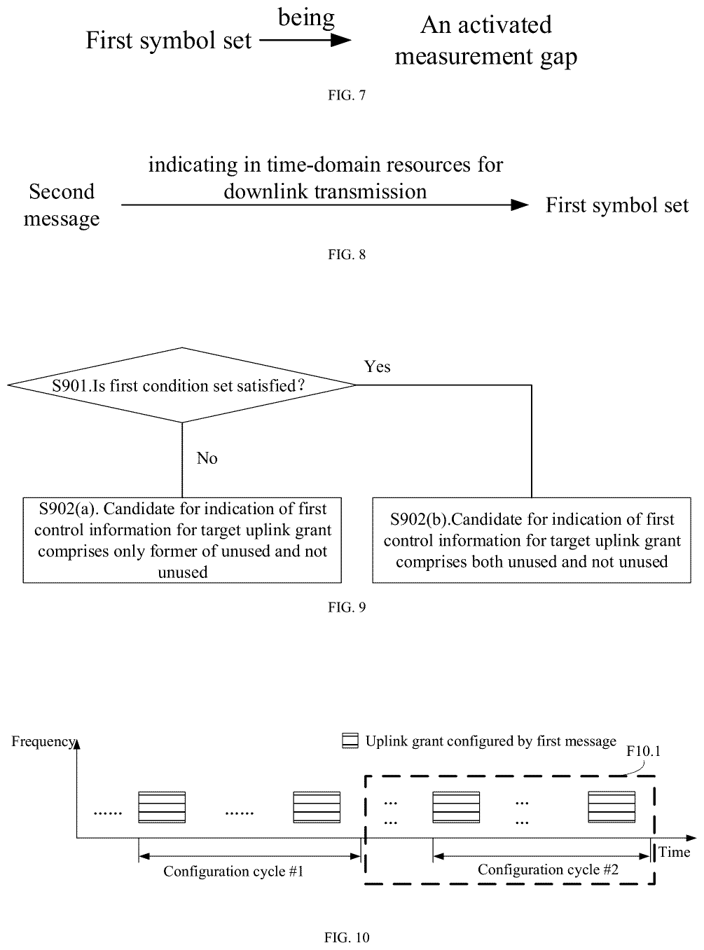

Embodiment 7 illustrates a schematic diagram of a first symbol set being an activated measured gap according to one embodiment of the present application, as shown in FIG. 7.

In embodiment 7, the first symbol set is an activated measurement gap.

In one embodiment, the above methods reduce the impact on an activated measurement gap.

In one embodiment, the first symbol set is a duration of an activated measurement gap.

In one embodiment, the first symbol set is time-domain resources occupied by an activated measurement gap.

In one embodiment, the first symbol set is configured for a time of an activated measurement gap.

In one embodiment, the activated measurement gap is used to perform a measurement.

In one embodiment, the activated measurement gap is an FR1 (Frequency range 1) measurement gap.

In one embodiment, the activated measurement gap is an FR2 (Frequency range 2) measurement gap.

In one embodiment, frequency-domain resources corresponding to the activated measurement gap overlap with frequency-domain resources of an uplink grant configured by the first message.

In one embodiment, frequency-domain resources corresponding to the activated measurement gap belong to frequency-domain resources of an uplink grant configured by the first message.

In one embodiment, frequency-domain resources of an uplink grant configured by the first message belong to frequency-domain resources corresponding to the activated measurement gap.

In one embodiment, frequency-domain resources corresponding to the activated measurement gap do not overlap with frequency-domain resources of an uplink grant configured by the first message.

### Embodiment 8

Embodiment 8 illustrates a schematic diagram of a second message indicating a first symbol set in time-domain resources for downlink transmission according to one embodiment of the present application, as shown in FIG. 8.

In embodiment 8, the second message indicates the first symbol set in time-domain resources for downlink transmission.

In one embodiment, each symbol in the first symbol set is a sub-band non-overlapping full duplex (SBFD) symbol.

In one embodiment, the first symbol set is configured for SBFD.

In one embodiment, the first symbol set is reserved for SBFD.

In one embodiment, the first RRC information block is used to configure time-domain resources for the downlink transmission.

In one embodiment, the first RRC information block is used to determine a slot configuration for uplink and downlink.

In one embodiment, the first RRC information block is used to determine a cell-dedicated uplink and downlink TDD configurations.

In one embodiment, the first RRC information block is used to determine a slot used for uplink transmission and a slot used for downlink transmission.

In one embodiment, the time-domain resources for downlink transmission are downlink slots.

In one embodiment, the time-domain resources for downlink transmission are flexible slots.

In one embodiment, the time-domain resources for downlink transmission are downlink slots or

flexible slots.

In one embodiment, the first RRC information block belongs to a SIBI (System Information Block 1) message.

In one embodiment, the first RRC information block belongs to a ServingCellConfigCommon IE.

In one embodiment, the first RRC information block belongs to a ServingCellConfigCommonSIB IE.

In one embodiment, the first RRC information block belongs to a BWP-Uplink IE.

In one embodiment, the first RRC information block belongs to a BWP-Uplink Common IE.

In one embodiment, the first RRC information block comprises a tdd-UL-DL-ConfigurationCommon field.

In one embodiment, the first RRC information block is a tdd-UL-DL-ConfigurationCommon field.

In one embodiment, the first RRC information block is an RRC field whose name comprises tdd-UL-DL-ConfigurationCommon.

In one embodiment, the first RRC information block comprises a TDD-UL-DL-ConfigCommon IE.

In one embodiment, the first RRC information block comprises a TDD-UL-DL-Pattern IE.

In one embodiment, the first RRC information block comprises a TDD-UL-DL-ConfigDedicated IE.

In one embodiment, when the first condition set is not met, an indication of the first control information for the target uplink grant can only be the only a former of the unused and the not unused.

In one embodiment, the above methods maintain the consistency of the protocol.

In one embodiment, the above methods reduce the impact of parameter changes on performance.

In one embodiment, when the first condition set is not met, an indication of the first control information for the target uplink grant can only be the only a latter of the unused and the not unused.

In one embodiment, the above methods improve resource utilization efficiency.

### Embodiment 9

Embodiment 9 illustrates a schematic diagram of determining a candidate for an indication of first control information for a target uplink grant according to one embodiment of the present application, as shown in FIG. 9.

The first node U01, in step S901, judges whether a first condition set is met; when the first condition set is not met, enters the step S902 (a); when the first condition set is met, enters the step S902 (b); in the step S902 (a), a candidate for an indication of the first control information for the target uplink grant comprises only a former of the unused and the not unused; in the step S902 (b), a candidate for an indication of the first control information for the target uplink grant comprises unused and not unused;

In embodiment 10, the phrase that a candidate for an indication of the first control information for the target uplink grant depends on a first condition set comprises: when the first condition set is met, a candidate for an indication of the first control information for the target uplink grant comprises unused and not unused; when the first condition set is not met, a candidate for an indication of the first control information for the target uplink grant comprises only a former of the unused and the not unused.

In one embodiment, in step S902 (a), an indication of the first control information for the target uplink grant is set as the unused.

In one embodiment, in step S902 (b), an indication of the first control information for the target uplink grant is set as the unused or the not unused.

In one embodiment, in the step S902 (b), an indication of the first control information for the target uplink grant is set as either the unused or the not unused based on a condition outside the first condition set.

### Embodiment 10

Embodiment 10 illustrates a schematic diagram of an uplink grant configured by a first message according to one embodiment of the present application, as shown in FIG. 10. In FIG. 10, the horizontal axis represents time; the vertical axis indicates frequency; each box filled with horizontal lines represents an uplink grant in uplink grants configured by the first message.

In embodiment 10, any two uplink grants configured by the first message are non-overlapping in time.

In one embodiment, the embodiment does not limit whether frequency-domain resources occupied by an uplink grant configured by the first message are the same.

In one embodiment, the embodiment does not limit whether a length of time-domain resources occupied by an uplink grant configured by the first message is the same.

In one embodiment, the embodiment does not limit whether a time-domain length between adjacent uplink grants configured by the first message is the same.

In one embodiment, the dotted box F10.1 is optional.

In one embodiment, an uplink grant configured by the first message belongs to configuration cycle #1, and the dotted box F10.1 does not exist.

In one embodiment, an uplink grant configured by the first message belongs to at least configuration cycle #1 and configuration cycle #2, and the dotted box F10.1 exists.

In one embodiment, configuration cycle #1 and configuration cycle #2 are two continuous configuration cycles.

In one embodiment, at least one configuration cycle is comprised between configuration cycle #1 and configuration cycle #2, and an uplink grant configured by the first message comprises the at least one configuration cycle.

In one embodiment, at least one configuration cycle is comprised between configuration cycle #1 and configuration cycle #2, and an uplink grant configured by the first message does not comprise the at least one configuration cycle.

In one embodiment, configuration cycle #1 and configuration cycle #2 belong to a same CG configuration.

In one embodiment, at least one ellipsis in FIG. 10 exists.

In one embodiment, at least one ellipsis in FIG. 10 does not exist.

### Embodiment 11

Embodiment 11 illustrates a schematic diagram of an uplink grant in uplink grants configured by a first message and a first symbol set according to one embodiment of the present application, as shown in FIG. 11. In FIG. 11, the horizontal axis represents time; the vertical axis represents frequency; each box filled with horizontal lines represents an uplink grant in uplink grants configured by the first message; the box filled with vertical lines is a first symbol set; the box 1101 represents a first uplink grant; time-domain resources of an uplink grant represented by box 1102 and a first symbol set represented by box 1104 are overlapping; time-domain resources of an uplink grant represented by box 1103 and a first symbol set represented by box 1104 are non-overlapping.

In embodiment 11, the first condition set comprises that the target uplink grant and the first symbol set are non-overlapping.

In one embodiment, an uplink grant represented by box 1102 is the target uplink grant, and a candidate for an indication of the first control information for the target uplink grant comprises only a former of unused and not unused.

In one embodiment, as long as the target uplink grant and the first symbol set are overlapping, an indication of the first control information for the target uplink grant can only be unused.

In one embodiment, as long as the target uplink grant and the first symbol set are overlapping, an indication of the first control information for the target uplink grant is not allowed to be unused.

In one embodiment, as long as the target uplink grant and the first symbol set are overlapping, an indication of the first control information for the target uplink grant is not determined by the UE implementation.

In one embodiment, an uplink grant represented by box 1103 is the target uplink grant, and a candidate for an indication of the first control information for the target uplink grant comprises both unused and not unused.

In one embodiment, the embodiment does not limit time-domain resources of an uplink grant represented by box 1102 and a starting time and a time-domain length of a first symbol set represented by box 1104.

In one embodiment, the embodiment does not limit whether frequency-domain resources occupied by an uplink grant configured by the first message are the same.

In one embodiment, the embodiment does not limit whether a length of time-domain resources occupied by an uplink grant configured by the first message is the same.

In one embodiment, the embodiment does not limit whether a time-domain length between adjacent uplink grants configured by the first message is the same.

In one embodiment, at least one ellipsis in FIG. 11 exists.

In one embodiment, at least one ellipsis in FIG. 11 does not exist.

### Embodiment 12

Embodiment 12 illustrates a schematic diagram of a first uplink grant, a second uplink grant and a target uplink according to one embodiment of the present application, as shown in FIG. 12. In FIG. 12, the horizontal axis represents time; the vertical axis represents frequency; the reticle-filled rectangle represents the second uplink grant; the rectangle filled with cross lines represents the first uplink grant; the slash-filled rectangle represents the first uplink grant.

In embodiment 11, the first condition set comprises that the second control information indicates that the target uplink grant is unused.

In one embodiment, the second control information transmitted in the second uplink grant indicates that the target uplink grant is not unused, and a candidate for an indication of the first control information for the target uplink grant comprises both the unused and the not unused.

In one embodiment, the second control information transmitted in the second uplink grant indicates that the target uplink grant is unused, and a candidate for an indication of the first control information for the target uplink grant comprises only a former of the unused and the not unused.

In one embodiment, as long as the second control information transmitted in the second uplink grant indicates that the target uplink grant is unused, an indication of the first control information for the target uplink grant can only be unused.

In one embodiment, as long as the second control information transmitted in the second uplink grant indicates that the target uplink grant is unused, an indication of the first control information for the target uplink grant is not allowed to be not unused.

In one embodiment, as long as the second control information transmitted in the second uplink grant indicates that the target uplink grant is unused, an indication of the first control information for the target uplink grant is not determined by the UE implementation.

In one embodiment, the embodiment does not limit whether frequency-domain resources occupied by the first uplink grant, the second uplink grant, and the target uplink grant are the same.

In one embodiment, the embodiment does not limit whether the first uplink grant, the second uplink grant, and the target uplink grant are adjacent uplink grants configured by the first message.

In one embodiment, at least one ellipsis in FIG. 12 exists.

In one embodiment, at least one ellipsis in FIG. 12 does not exist.

### Embodiment 13

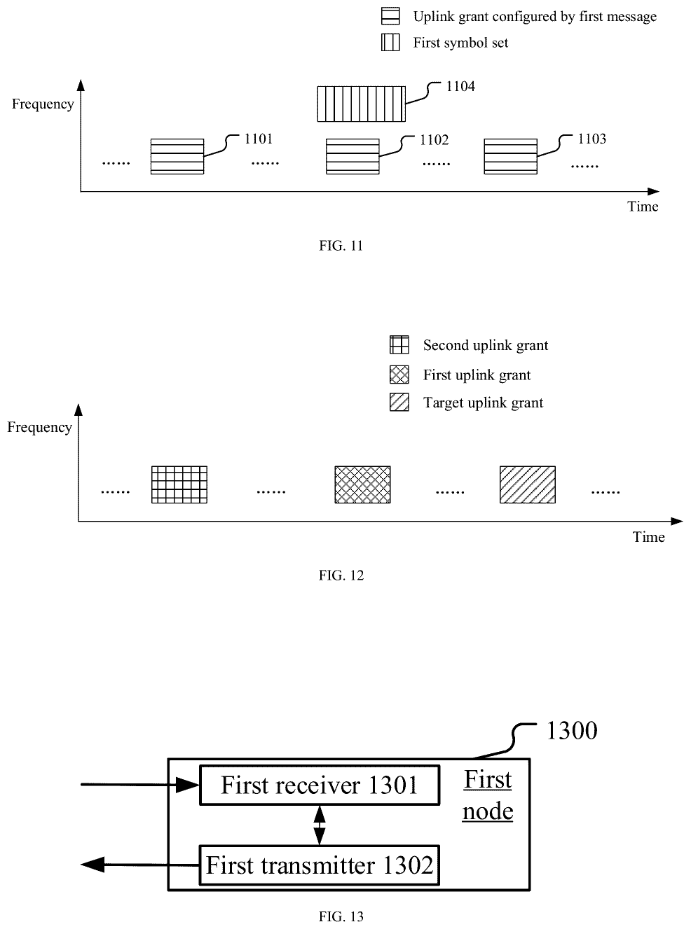

Embodiment 13 illustrates a structure block diagram of a processor in a first node according to one embodiment of the present application, as shown in FIG. 13. In FIG. 13, a processor 1300 of the first node comprises a first receiver 1301 and a first transmitter 1302.

The first receiver 1301 receives a first message, the first message is configured with an uplink grant, and any two uplink grants configured by the first message are non-overlapping in time;
the first transmitter 1302 transmits first control information in a first uplink grant, the first control information indicates whether a target uplink grant is unused, the first uplink grant and the target uplink grant are configured by the first message, the target uplink grant is after the first uplink grant;

In embodiment 13, a candidate for an indication of the first control information for the target uplink grant depends on a first condition set; the phrase that a candidate for an indication of the first control information for the target uplink grant depends on a first condition set comprises: when the first condition set is met, a candidate for an indication of the first control information for the target uplink grant comprises unused and not unused.

In one embodiment, the first receiver 1301 receives a second message, and the second message indicates a first symbol set; herein, the first condition set comprises that the target uplink grant and the first symbol set are non-overlapping.

In one embodiment, the first transmitter 1302 transmits second control information in a second uplink grant, the second control information indicates whether the target uplink grant is unused, the second uplink grant is configured by the first message, the second uplink grant is prior to the first uplink grant; herein, the first condition set comprises that the second control information indicates that the target uplink grant is unused.

In one embodiment, the first transmitter 1302 transmits second control information in a second uplink grant, the second control information indicates that the target uplink grant is unused, the second uplink grant is configured by the first message, and the second uplink grant is prior to the first uplink grant; herein, the first condition set comprises that the first signaling is not received; the second control information triggers the first signaling.

In one embodiment, the first transmitter 1302 transmits second control information in a second uplink grant, the second control information indicates that the target uplink grant is unused, the second uplink grant is configured by the first message, and the second uplink grant is prior to the first uplink grant; herein, the first condition set comprises that a first time interval reaches a first threshold; the first time interval is related to two of the first uplink grant or the second uplink grant or the target uplink grant.

In one embodiment, the phrase that a candidate for an indication of the first control information for the target uplink grant depends on a first condition set comprises: when the first condition set is not met, a candidate for an indication of the first control information for the target uplink grant comprises only a former of the unused and the not unused.

In one embodiment, the first condition set comprises that the target uplink is not indicated by control information prior to the first control information.

In one embodiment, the first receiver 1301 comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 1301 comprises the antenna 452, the receiver 454, the multi-antenna receiving processor 458 and the receiving processor 456 in FIG. 4 of the present application.

In one embodiment, the first receiver 1301 comprises the antenna 452, the receiver 454 and the receiving processor 456 in FIG. 4 of the present application.

In one embodiment, the first transmitter 1302 comprises the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1302 comprises the antenna 452, the transmitter 454, the multi-antenna transmitting processor 457 and the transmitting processor 468 in FIG. 4 of the present application.

In one embodiment, the first transmitter 1302 comprises the antenna 452, the transmitter 454 and the transmitting processor 468 in FIG. 4 of the present application.

### Embodiment 14

Embodiment 14 illustrates a structure block diagram of a processor in a second node according to one embodiment of the present application, as shown in FIG. 14. In FIG. 14, a processor 1400 of the second node comprises a second transmitter 1401 and a second receiver 1402.
the second transmitter 1401 transmits a first message, the first message is configured with an uplink grant, and any two uplink grants configured by the first message are non-overlapping in time;
the second receiver 1402 receives first control information, the first control information indicates whether a target uplink grant is unused, a first uplink grant and the target uplink grant are configured by the first message, the target uplink grant is after the first uplink grant;
in embodiment 14, a receiver of the first message transmits the first control information in the first uplink grant; a candidate for an indication of the first control information for the target uplink grant depends on a first condition set; the phrase that a candidate for an indication of the first control information for the target uplink grant depends on a first condition set comprises: when the first condition set is met, a candidate for an indication of the first control information for the target uplink grant comprises unused and not unused.

In one embodiment, the second transmitter 1401 transmits a second message, and the second message indicates a first symbol set; herein, the first condition set comprises that the target uplink grant and the first symbol set are non-overlapping.

In one embodiment, the second receiver 1402 receives second control information, the second control information indicates whether the target uplink grant is unused, the second uplink grant is configured by the first message, the second uplink grant is prior to the first uplink grant; herein, a receiver of the first message transmits the second control information in a second uplink grant; the first condition set comprises that the second control information indicates that the target uplink grant is not unused.

In one embodiment, the second receiver 1402 receives second control information, the second control information indicates that the target uplink grant is unused, the second uplink grant is configured by the first message, the second uplink grant is prior to the first uplink grant; herein, a receiver of the first message transmits the second control information in a second uplink grant; the first condition set comprises that the first signaling is not received; the second control information triggers the first signaling.

In one embodiment, the second receiver 1402 receives second control information, the second control information indicates that the target uplink grant is unused, the second uplink grant is configured by the first message, the second uplink grant is prior to the first uplink grant; herein, a receiver of the first message transmits the second control information in a second uplink grant; the first condition set comprises that a first time interval reaches a first threshold; the first time interval is related to two of the first uplink grant or the second uplink grant or the target uplink grant.

In one embodiment, the phrase that a candidate for an indication of the first control information for the target uplink grant depends on a first condition set comprises: when the first condition set is not met, a candidate for an indication of the first control information for the target uplink grant comprises only a former of the unused and the not unused.

In one embodiment, the first condition set comprises that the target uplink is not indicated by control information prior to the first control information.

In one embodiment, the second transmitter 1401 comprises the antenna 420, the transmitter 418, the multi-antenna transmitting processor 471, the transmitting processor 416, the controller/processor 475 and the memory 476 in FIG. 4 of the present application.

In one embodiment, the second transmitter 1401 comprises the antenna 420, the transmitter 418, the multi-antenna transmitting processor 471 and the transmitting processor 416 in FIG. 4 of the present application.

In one embodiment, the second transmitter 1401 comprises the antenna 420, the transmitter 418 and the transmitting processor 416 in FIG. 4 of the present application.

In one embodiment, the second receiver 1402 comprises the antenna 420, the receiver 418, the multi-antenna receiving processor 472, the receiving processor 470, the controller/processor 475 and the memory 476 in FIG. 4 of the present application.

In one embodiment, the second receiver 1402 comprises the antenna 420, the receiver 418, the multi-antenna receiving processor 472 and the receiving processor 470 in FIG. 4 of the present application.

In one embodiment, the second receiver 1402 comprises the antenna 420, the receiver 418 and the receiving processor 470 in FIG. 4 of the present application.

### Embodiment 15

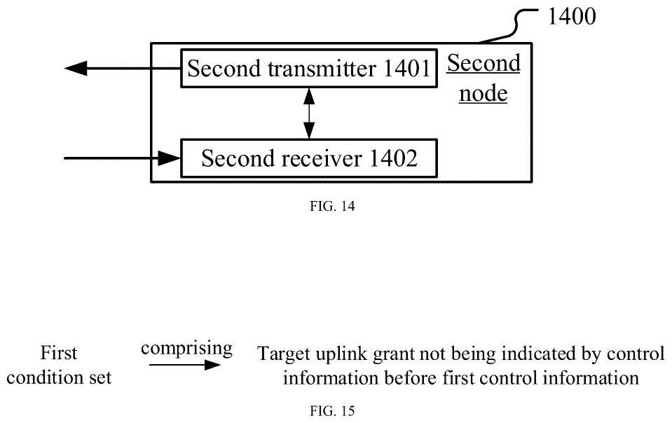

Embodiment 15 illustrates a schematic diagram of a whether a first condition set comprises that a target uplink grant is indicated by control information prior to first control information according to one embodiment of the present application, as shown in FIG. 15.

In embodiment 15, the first condition set comprises that the target uplink is not indicated by control information prior to the first control information.

In one embodiment, if the target uplink is indicated by control information prior to the first control information, the first condition set is not met; if the target uplink grant is not indicated by any control information prior to the first control information, the first condition set is met.

In one embodiment, if the target uplink grant is indicated by control information prior to the first control information, a candidate for an indication of the first control information for the target uplink grant comprises only one of the unused and the not unused; indications of the only one and the control information prior to the first control information for the target uplink grant are the same.

In one embodiment, if the target uplink grant is indicated by control information prior to the first control information, an indication of the first control information for the target uplink grant and an indication of the control information prior to the first control information for the target uplink grant are the same.

In one embodiment, only when the target uplink grant is not indicated by any control information prior to the first control information, a candidate for an indication of the first control information for the target uplink grant comprises unused and not unused.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, tele-controlled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IoT terminals, Machine Type Communication (MTC) terminals, enhanced MTC (eMTC) terminals, data card, network cards, vehicle-mounted communication equipment, low-cost mobile phones, low-cost tablets and other wireless communication devices. The UE and terminal in the present application include but not limited to unmanned aerial vehicles, communication modules on unmanned aerial vehicles, tele-controlled aircrafts, aircrafts, diminutive airplanes, mobile phones, tablet computers, notebooks, vehicle-mounted communication equipment, wireless sensor, network cards, terminals for Internet of Things, RFID terminals, NB-IoT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first message, the first message being configured with an uplink grant, and any two uplink grants configured by the first message being non-overlapping in time; and
a first transmitter, transmitting first control information in a first uplink grant, the first control information indicating whether a target uplink grant is unused, the first uplink grant and the target uplink grant being configured by the first message, the target uplink grant being after the first uplink grant;
wherein a candidate for an indication of the first control information for the target uplink grant depends on a first condition set; the phrase that a candidate for an indication of the first control information for the target uplink grant depends on a first condition set comprises: when the first condition set is met, a candidate for an indication of the first control information for the target uplink grant comprises unused and not unused.

2. The first node according to claim 1, wherein the first control information is a UTO-UCI (Unused Transmission Occasion-Uplink Control Information); a number of bit(s) occupied by the first control information is configurable.

3. The first node according to claim 1, wherein control information comprises a bitmap, and any bit in the bitmap corresponds to an uplink grant; if a bit in the bitmap in the control information is set to 1, the control information indicates that an uplink grant corresponding to the bit is unused; if a bit in the bitmap in the control information is set to 0, the control information indicates that an uplink grant corresponding to the bit is not unused.

4. The first node according to claim 1, wherein the target uplink grant is an uplink grant indicated by the first control information after the first uplink grant.

5. The first node according to claim 1, wherein the target uplink grant is any uplink grant belonging to a same configuration cycle after the first uplink grant, or the target uplink grant is an uplink grant belonging to a different configuration cycle after the first uplink grant.

6. The first node according to claim 1, wherein when the first condition set is not met, an indication of the first control information for the target uplink grant can only be the unused.

7. The first node according to claim 1, comprising:
the first receiver, receiving a second message, the second message indicating a first symbol set;
wherein the first condition set comprises that the target uplink grant and the first symbol set are non-overlapping.

8. The first node according to claim 7, wherein a first RRC information block is used to configure the time-domain resources for downlink transmission; the first RRC information block comprises a tdd-UL-DL-ConfigurationCommon field, or the first RRC information block comprises a TDD-UL-DL-ConfigDedicated IE.

9. The first node according to claim 7, wherein as long as the target uplink grant and the first symbol set are overlapping, an indication of the first control information for the target uplink grant is not allowed to be not unused.

10. The first node according to claim 1, comprising:
the first transmitter, transmitting second control information in a second uplink grant, the second control information indicating whether the target uplink grant is not unused, the second uplink grant being configured by the first message, the second uplink grant being prior to the first uplink grant;
wherein the first condition set comprises that the second control information indicates that the target uplink grant is unused.

11. The first node according to claim 10, wherein as long as the second control information transmitted in the second uplink grant indicates that the target uplink grant is unused, an indication of the first control information for the target uplink grant can only be unused.

12. The first node according to claim 10, wherein the second uplink grant and the first uplink grant belong to a same configuration cycle, or the second uplink grant and the first uplink grant belong to different configuration cycles.

13. The first node according to claim 10, wherein the second uplink grant and the target uplink grant belong to a same configuration cycle, or the second uplink grant and the target uplink grant belong to different configuration cycles.

14. The first node according to claim 10, wherein when the second control information indicates that the target uplink grant is not unused, a candidate for an indication of the first control information for the target uplink grant comprises unused and not unused; when the second control information indicates that the target uplink grant is unused, a candidate for an indication of the first control information for the target uplink grant comprises only a former of unused and not unused.

15. The first node according to claim 1, comprising:
the first transmitter, transmitting second control information in a second uplink grant, the second control information indicating that the target uplink grant is unused, the second uplink grant being configured by the first message, the second uplink grant being prior to the first uplink grant;
wherein the first condition set comprises that the first signaling is not received; the second control information triggers the first signaling.

16. The first node according to claim 1, comprising:
the first transmitter, transmitting second control information in a second uplink grant, the second control information indicating that the target uplink grant is unused, the second uplink grant being configured by the first message, the second uplink grant being prior to the first uplink grant;
wherein the first condition set comprises that a first time interval reaches a first threshold; the first time interval is related to two of the first uplink grant or the second uplink grant or the target uplink grant.

17. The first node according to claim 1, wherein the phrase that a candidate for an indication of the first control information for the target uplink grant depends on a first condition set comprises: when the first condition set is not met, a candidate for an indication of the first control information for the target uplink grant comprises only a former of the unused and the not unused.

18. The first node according to claim 1, wherein the first condition set comprises that the target uplink is not indicated by control information prior to the first control information.

19. A second node for wireless communications, comprising:
a second transmitter, transmitting a first message, the first message being configured with an uplink grant, and any two uplink grants configured by the first message being non-overlapping in time; and
a second receiver, receiving first control information, the first control information indicating whether a target uplink grant is unused, a first uplink grant and the target uplink grant being configured by the first message, the target uplink grant being after the first uplink grant;
wherein a receiver of the first message transmits the first control information in the first uplink grant; a candidate for an indication of the first control information for the target uplink grant depends on a first condition set; the phrase that a candidate for an indication of the first control information for the target uplink grant depends on a first condition set comprises: when the first condition set is met, a candidate for an indication of the first control information for the target uplink grant comprises unused and not unused.

20. A method in a first node for wireless communications, comprising:
receiving a first message, the first message being configured with an uplink grant, and any two uplink grants configured by the first message being non-overlapping in time; and
transmitting first control information in a first uplink grant, the first control information indicating whether a target uplink grant is unused, the first uplink grant and the target uplink grant being configured by the first message, the target uplink grant being after the first uplink grant;
wherein a candidate for an indication of the first control information for the target uplink grant depends on a first condition set; the phrase that a candidate for an indication of the first control information for the target uplink grant depends on a first condition set comprises: when the first condition set is met, a candidate for an indication of the first control information for the target uplink grant comprises unused and not unused.
